(19) United States
(12) Patent Application Publication
(10) Pub. No.: US 2026/0303608 A1
(43) Pub. Date: Oct. 1, 2026

(54) Dynamic Access Roles

(71) Applicant: SailPoint Technologies, Inc., Austin, TX (US)

(72) Inventors: Ryan Allan Pickens, Salt Lake City, UT (US); Patrick Gookin, Marina Del Rey, CA (US)

(21) Appl. No.: 19/636,756

(22) Filed: Apr. 1, 2026

Related U.S. Application Data
(60) Provisional application No. 63/781,840, filed on Apr. 1, 2025.

(51) Int. Cl. H04L 9/40

(52) U.S. Cl. CPC H04L 63/104; H04L 63/102

(57) ABSTRACT

Embodiments of the present disclosure provide systems and methods for dynamic access roles that can contextually assign access rights to users within a role. A dynamic access role comprises a role dimension that has a dimension criteria. The role dimension further comprises a dimension-level entitlement to be provisioned to members of the dynamic access role that satisfy the dimension criteria. User assignment contexts are evaluated to contextually assign the role dimension to users that satisfy the role membership criteria and the dimension criteria. Thus, role members can be contextually assigned the dimension and provisioned the dimension-level entitlement. The dynamic access role may have multiple such dimensions with single attribute or multi-attribute dimension criteria. Dimension-level entitlements may be assigned in addition to any role-level entitlements that get assigned to all members of the role.

### RELATED APPLICATION(S)

This application claims the benefit of priority under 35 U.S.C. § 119 (e) of U.S. Provisional Patent Application 63/781,840, filed Apr. 1, 2025, entitled “Dynamic Access Roles,” which is hereby fully incorporated by reference herein.

### TECHNICAL FIELD

This disclosure relates generally to computer security. In particular, this disclosure relates to role-based access control (RBAC). Even more particularly, this disclosure relates to contextual provisioning of access rights within a role.

### BACKGROUND

Role-based access control (RBAC) systems are used to manage user access to critical applications and data. In an RBAC solution, roles are used to control access for groups of users who have the same or similar job responsibilities. This is intended to provide an abstraction which allows non-technical business focused users to concentrate on a user's job responsibilities (roles) in the organization independently from the actual access rights that are needed to fulfill those responsibilities.

RBAC solutions assign a common set of access rights to all members of a role. This provides a very clear and simple way of managing access rights for a given population of users. If a user has a role, they have all of the access rights that are assigned by the role. However, the simplicity of this approach is also a challenge as most organizations are not simple. Users with the same job responsibilities may need different access rights based on the specific context of their job role.

To address this, in a standard RBAC model, a role must be created for every variation or access rights to be assigned. For example, all store clerks need access to the point-of-sale system but their actual access is based on the store location to which they are assigned. To model this with a traditional role model, an organization would need to create a role for every store location. In many cases, there are many more variables involved and combinations of variables are also needed. This can result in hundreds, thousands, and even hundreds of thousands of roles being created in order to assign the right access to the right people.

Consequently, in many enterprise computing environments, the number of defined RBAC roles can proliferate far beyond the number of distinct job functions or operational responsibilities within the organization. This condition, commonly termed “role explosion,” results in an excessively granular and unwieldy role hierarchy. Role explosion frequently gives rise to role definitions having cryptic, non-descriptive, or inconsistent naming conventions, thereby obscuring the relationship between a given role and the underlying job duties it is intended to represent. As a consequence, system administrators, human-resources personnel, managers, and other stakeholders often encounter significant difficulty in accurately determining which roles should be assigned to a user during onboarding, job transitions, or changes in access requirements.

Moreover, each role instance typically requires the maintenance of associated metadata which must be stored, processed, and periodically audited. As the number of roles increases, the cumulative metadata load imposes substantial overhead on storage subsystems, access-control engines, and directory services. Accordingly, role explosion can degrade system performance, reduce scalability, increase latency in authorization operations, and exacerbate administrative burden. The net effect is heightened operational cost, increased complexity in access-governance workflows, and diminished user experience across the lifecycle of access management activities.

### SUMMARY

Embodiments of the present disclosure relate to systems and methods for providing context-sensitive and selectively assigned access rights within roles. In contrast to conventional roles-based access control (RBAC) models that universally assign entitlements to all members of a role, embodiments of the present disclosure comprise dynamic access roles (DARs) configured to assign entitlements conditionally based on user-specific contextual attributes.

One aspect of the present disclosure includes a method assigning access rights. Another aspect of the present disclosure comprises an identity management system. The identity management system may comprise a processor and computer readable medium. The computer readable medium may comprise computer instructions executable to cause the system to implement a method for contextually assigning access rights within roles. Yet another aspect of the present disclosure comprises a non-transitory computer readable medium comprising computer instructions executable to cause a processor to implement a method for assigning access rights.

The method for assigning access rights comprises contextually assigning access rights within roles. The method may comprise maintaining a dynamic access role. The dynamic access role may include role membership criteria for determining which users qualify for role membership, as well as a role dimension. The role dimension may comprise a dimension criteria and a dimension-level entitlement to be granted to members of the dynamic access role that satisfy the dimension criteria. The method may thus comprise evaluating user assignment contexts for users to contextually assign the role dimension to users that satisfy the role membership criteria and the dimension criteria. The method may further include provisioning the dimension-level entitlement to the users assigned the role dimension. A DAR may also include a role-level entitlement to be granted to all members of the role regardless of whether dimension criteria are met. Some embodiments may comprise evaluating access requests that include the assignment contexts. The access requests may be, for example, requests to assign the users to the dynamic access role. The access requests may be evaluated to assign users who meet the role membership criteria as users of the dynamic access role and assign the dimension to the users who meet the role membership criteria and the dimension criteria.

In some embodiments, the dimension criteria may comprise a criteria expression that evaluates context attribute values for the users. In some embodiments, the DAR identifies the specific context attributes, such as location, department, project identifier, job classification, or other enterprise-defined attributes, to be used for dimension assignment and the DAR may support multi-attribute, context-based entitlement assignment. One or more context attribute values for a user may be sourced from the identity profile associated with a user, where the identity profile includes identity attributes for the user. In addition, or in the alternative, one or more context attribute values for a user may be provided by a user or process submitting the access request.

In certain embodiments, a DAR may include a plurality of role dimensions. In some embodiments, each role dimension of a DAR is associated with a different combination of context attribute-value conditions.

In some embodiments, the method includes automatically propagating modifications made to a role dimension (e.g., creation, removal from a DAR, updates to dimension criteria, updates to dimension-level entitlements) to current members of the dynamic access role. Such propagation may include automatically assigning the dimension to qualifying role members, granting newly applicable dimension-level entitlements to qualifying role members, unassigning the role from role members (all role members or role members who no longer quality for the dimension), or revoking dimension-level entitlements that no longer apply.

DARs provide an advantage over roles in conventional RBAC systems by assigning access contextually. That is, DARs can selectively assign access to members based on an assignment context. DARs can result in smaller overall role models (e.g., a dimensional role assignment can replace multiple roles), reduced role model administration and maintenance, and simplified end user experiences.

The use of DARs can facilitate consolidating access policies and controls. Access policies in current systems are often distributed across many roles. DARs, on the other hand, can encapsulate these policies through dimensional access.

DARs can provide business users with a simplified experience that hides role model complexity. Access can be requested and certified based on easily understandable contexts, not cryptic names/descriptions.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 is a block diagram of one embodiment of a distributed networked computer environment including an identity management system.

FIG. 2 is a block diagram of one embodiment of a microservices architecture for role-based access control.

FIG. 3A is a diagrammatic representation of one embodiment of a dynamic access role.

FIG. 3B is a diagrammatic representation of one embodiment of evaluating a first access request against the dynamic access role of FIG. 3A.

FIG. 3C is a diagrammatic representation of one embodiment of evaluating a second access request against the dynamic access role of FIG. 3A.

FIG. 3D is a diagrammatic representation of one embodiment of evaluating a third access request against the dynamic access role of FIG. 3A.

FIG. 3E is a diagrammatic representation of one embodiment of evaluating a fourth access request against the dynamic access role of FIG. 3A.

FIG. 4A illustrates one embodiment of a user interface (UI) screen used by a role administrator to create or edit a role.

FIG. 4B illustrates one embodiment of a UI screen used by the role administrator to specify members or membership criteria for role membership.

FIG. 4C illustrates an embodiment of a UI screen used to assign access items to a role.

FIG. 4D illustrates an embodiment of a UI screen used to select which identity attributes are to be used in role dimensions.

FIG. 4E illustrates an embodiment of a UI screen used to select the dimensions that apply to the role.

FIG. 4F illustrates an embodiment of a UI screen used to edit a dimension.

FIG. 4G illustrates another embodiment of a UI screen used to edit a dimension and, more particularly, to assign dimension criteria.

FIG. 4H illustrates another embodiment of a UI screen used to edit a dimension and, more particularly, to assign entitlements to the dimension.

FIG. 5 is a block diagram illustrating an example of one embodiment of a dynamic access role contrasted with multiple standard roles.

FIG. 6 is a flowchart illustrating one embodiment of a method 600 for provisioning entitlements.

FIG. 7 illustrates one embodiment of a computer system that may implement contextual assignment of access rights within roles.

### DETAILED DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

Current role-based access control (RBAC) models are not adequate for defining, maintaining, and enforcing the complex and context sensitive access policies required by modern organizations. Standard roles assign access universally such that all role members are given the same role-based access. This results in unmanageable access models as evidenced by role explosion, increased administrative costs, poor access request experiences, and difficulty in proving compliance.

Dynamic Access Roles (DARs) according to the present disclosure address these problems by allowing roles to selectively assign entitlements (access rights) to role members based on the context of their role assignment. This eliminates the need to create a unique role for every variation of a job responsibility just because the access that needs to be assigned varies even slightly. A single or a small number of DARs can replace tens, hundreds, or thousands of conventional roles. DARs accomplish this through the use of role dimensions and context attributes. Each dimension of a role may comprise a policy statement that evaluates context attribute value expressions to determine the specific access rights to grant to individual role members. For example, a “Sales Clerk” role could use store location dimensions to grant the correct access rights to store clerks based on the store locations to which they are assigned.

According to embodiments of the present disclosure, a role assignment context provides information that may be used by a DAR to determine the dimension-based access that should be assigned to a role member. In some embodiments, the role assignment context is a set of name value pairs which can be provided when a role assignment is requested manually or automatically. The role assignment context may include, for example, attribute values derived from a user's identity profile or other sources.

The role dimensions determine the specific access that should be assigned to a user based on the assignment context. A role dimension, according to one embodiment, includes an access mapping and dimension criteria. In some embodiments, the dimension criteria comprises a dimension criteria expression such as a context attribute expression that evaluates a user's context (dimensional) attribute values to determine if the user should be assigned to the dimension and be provisioned with the dimension's access rights. If the role member meets the criteria for the dimension, they are assigned the dimension and are granted the associated access. For example, a Sales Clerk role can be configured with a dimension named “London Access” and a criteria expression “Store Location Equals London” which grants access to an entitlement in the point-of-sale system, such that if a user is assigned the Sales Clerk role with the value of London for their Store Location, they will be assigned the London Access dimension and will be granted the correct entitlement in the point-of-sale system. A DAR may have many dimensions and, in some embodiments, each dimension's criteria evaluates a unique combination of attribute-value conditions to determine the appropriate access rights to assign.

Some embodiments support non-DAR roles (referred to as RBAC roles) and DARs. RBAC roles may function in a manner consistent with conventional or other RBAC systems, wherein entitlements assigned to an RBAC role are granted to all members of that role. In some embodiments, a DAR may behave like an RBAC role with respect to entitlements assigned directly at the role level such that entitlements explicitly assigned to a DAR at the role level are propagated to all members of the DAR. Accordingly, at the level of coarse-grained entitlement assignment, DARs may operate substantially similarly to RBAC roles.

In some embodiments, an RBAC and the base configuration of a DAR have similar metadata, such as a role id, a role name or another role identifier, a role description, a role owner, optional membership criteria, the role's approval policy, and a set of entitlements to assign to all role members. However, unlike RBAC roles, a DAR may additionally include one or more role dimensions to selectively assign entitlements to role members. The dimensions enable fine-grained, contextual entitlement assignment such that access may be selectively granted to different subsets of DAR members based on the context attribute values applicable to each user.

RBAC roles and DARs can be automatically assigned to users or they can be assigned directly through ad-hoc access requests or assignment processes and all users who become members of a role may be granted the access that is defined for the RBAC role or the DAR at the role level. DARs, however, can extend RBAC role behavior by providing an additional level of evaluation and processing of each role assignment. For a user assigned a DAR, the role determines if additional access should be assigned by evaluating the role's dimension criteria against the user's role assignment context. According to one embodiment, if the user's role assignment context satisfies a dimension's criteria, the user is assigned the dimension and is granted all of the dimension's access rights.

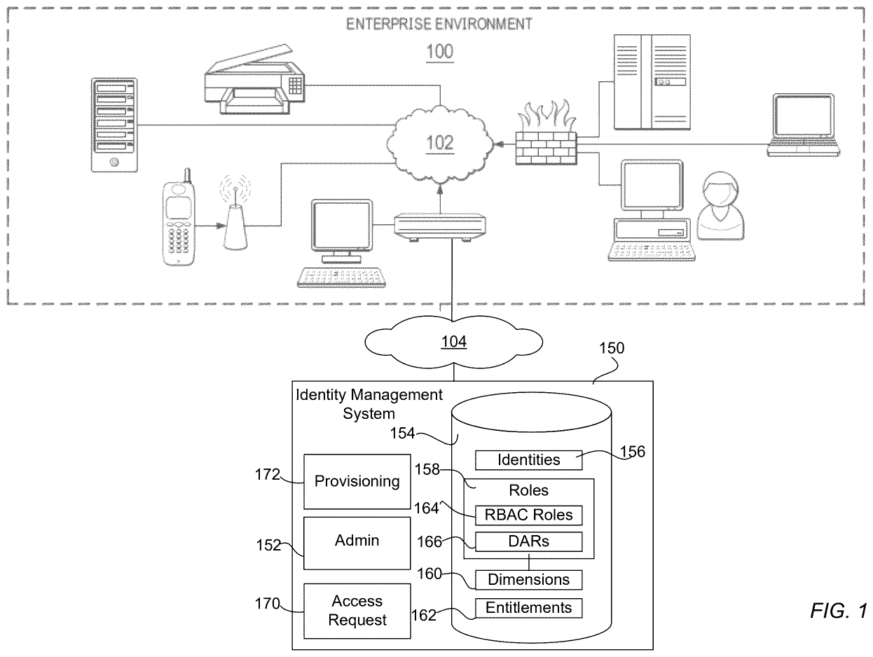

FIG. 1 is a diagrammatic representation of a distributed networked computer environment including one embodiment of an identity management system 150 for determining access items. Here, the networked computer environment may include an enterprise computing environment 100. Enterprise computing environment 100 includes a number of computing devices or applications that may be coupled over a computer network 102 or combination of computer networks, such as the Internet, an intranet, an internet, a Wide Area Network (WAN), a Local Area Network (LAN), a cellular network, a wireless or wired network, or another type of network. Enterprise computing environment 100 may thus include a number of resources, various resource groups and users associated with an enterprise (for purposes of this disclosure any for profit or non-profit entity or organization). Users may have various roles, job functions (e.g., job titles), responsibilities, etc. to perform within various processes or tasks associated with enterprise computing environment 100. Users can include employees, supervisors, managers, IT personnel, vendors, suppliers, customers, robotic or application-based users, etc. associated with enterprise computing environment 100.

Users may access resources of the enterprise computing environment 100 to perform functions associated with their jobs, obtain information about enterprise computing environment 100 and its products, services, and resources, enter or manipulate information regarding the same, monitor activity in enterprise computing environment 100, order supplies and services for enterprise computing environment 100, manage inventory, generate financial analyses and reports, or generally to perform any task, activity or process related to the enterprise computing environment 100. Thus, to accomplish their responsibilities, users may have entitlements to access resources of the enterprise computing environment 100. To accomplish different functions, different users may have differing access entitlements to differing resources.

To assist in managing the entitlements assigned to various users in enterprise computing environment 100, an identity management system 150 may be employed. Identity management system 150 provides a centralized platform for defining, maintaining, and governing digital identities and the corresponding access rights associated with those identities within enterprise computing environment 100. The system maintains identity profiles for users and other entities, where each profile may comprise identity attributes relevant to determining access requirements. The system further maintains roles, entitlements, and access policies that collectively define the permissions to be assigned to identities. Through administrative and authorized user interfaces, automated policy engines, and access-request workflows, the identity management system 150 evaluates access requests, determines appropriate role, role dimension and entitlement assignments, and provisions or revokes access rights to connected applications and resources. The identity management system 150 may implement approval workflows, attribute-based rules, and separation-of-duty constraints to ensure that access is granted in accordance with organizational policy. Additionally, the identity management system 150 can continuously monitor identity attributes, detect changes affecting access eligibility, and automatically adjust assigned roles, role dimensions and entitlements in response.

Identity management system 150 may request or otherwise obtain data from various touchpoint systems within enterprise computing environment 100 and interact with various touchpoint systems to provision entitlements to users. Examples of these touchpoint systems include, but are not limited to, Active Directory systems, Java Database Connectors within the enterprise computing environment 100, Microsoft SQL servers, Azure Active Directory servers, OpenLDAP servers, Oracle Databases, SalesForce applications, ServiceNow applications, SAP applications or Google GSuite, among others (all trademarks, tradenames, service marks and the like used herein are the property of their respective owners).

Identity management system 150 allows administrative or other types of user to define one or more identities, one or more entitlements, or one or more roles, and one or more dimensions and associate defined identities with entitlements using, for example, an administrator interface 152. The assignment may occur, for example, by directly assigning an entitlement to an identity, or by assigning a role to an identity whereby the entitlements associated with a role or one or more role dimensions may be associated with the identity. Note here, that while the identity management system 150 has been depicted in the diagram as separate and distinct from the enterprise computing environment 100 and coupled to enterprise computing environment 100 over a computer network 104 (which may the same as, or different than, network 102), it will be realized that such an identity management system 150 may be deployed as part of the enterprise computing environment 100, remotely from the enterprise environment, as a cloud based application or set of services, or in another configuration. In some embodiments, identity management system 150 is deployed according to a cloud-based microservice architecture.

An identity may represent almost any physical or virtual thing, place, person or other item that an enterprise would like to define. For example, an identity may represent a capacity, group, process, physical location, individual user or almost any other physical or virtual entity, place, person or other item. An entitlement may represent one or more access rights that upon provisioning to a user will allow the user to acquire a certain account or privileged access level that enables the user to perform a certain function within the enterprise computing environment 100. Thought of another way, an entitlement may be a specific permission granted within a computer system, such as access to files and folders, access to features, or access to certain parts of websites. Entitlements may define the actions a user can take against the items to which they have access. Each of these identities may therefore be assigned zero or more entitlements with respect to the distributed networked computer environments.

To facilitate the assignment of these entitlements, enterprise computing environment 100 may also be provided with the ability to define roles and role dimensions (e.g., through the identity management system 150). A role within the context of the identity management system 150 may comprise a collection of entitlements. These roles may be assigned a name or identifiers by an enterprise that designates the type of user or identity that should be assigned such a role. By assigning a role to an identity using the identity management system 150, the identity may be assigned a corresponding collection of entitlements associated with the assigned role. The corresponding collection of entitlements may include role-level entitlements and dimension-level entitlements for which the identity qualifies.

The identity management system 150 may store identity management data 154 that includes identities 156, roles 158, dimensions 160 and entitlements 162. Identities 156 may comprise identity profiles for users and other entities, where an identity profile comprises identity attributes, where each identity profile comprises identity attributes relevant to determining access for the corresponding entity. In some implementations, identity attributes in identity management system 150 map to attributes from application or systems in enterprise computing environment 100. For example, data associated with an identity may be provided from other systems such as a job title, location or department associated with the identity. The identity management data 154 may include a set of entries for identities where each such entry may include an identity identifier and a vector or list of entitlements, roles and role dimensions assigned to that identity by the identity management system 150. Other data could also be associated with each identity.

The set of roles 158 may include both RBAC roles 164 and DARs 166. The RBAC roles 164 may operate in a manner consistent with conventional RBAC systems, such that any entitlements associated with an RBAC role 164 are granted to all users who are members of that role. A DAR 166 may similarly assign entitlements that are explicitly associated with the DAR at the role level. Thus, entitlements to an RBAC role or to a DAR at the role level, may be referred to as role-level entitlements. The identity management data 154 may include a set of entries corresponding to roles, each such entry may include a role identifier and a vector or list of entitlements (e.g., role-level entitlements) assigned to that role by identity management system 150 and, for DARs, dimensions assigned to that role by identity management system 150. Other data could also be associated with each role.

In contrast to RBAC roles 164, DARs 166 may further comprise one or more dimensions 160 that selectively assign additional entitlements to role members based on context-dependent evaluation criteria. A dimension of a role may be referred to as a role dimension, where each role dimension corresponds to a (role: dimension) tuple defining a unique conditional access component of the DAR. The identity management data 154 may include a set of entries corresponding to dimensions, each such entry may include a dimension identifier and a vector or list of entitlements assigned to that dimension by identity management system 150. Other data could also be associated with each dimension.

In some embodiments, the role dimensions of a DAR 166 are defined as part of the DAR's configuration. In other embodiments, the dimensions 160 may be defined independently of any particular DAR and subsequently included in one or more DARs by reference. In certain embodiments, a given dimension 160 is exclusive to a single DAR, whereas in other embodiments, a dimension 160 may be shared among multiple DARs, thereby forming corresponding role dimensions for each DAR to which the dimension is assigned.

Each role dimension of a DAR 166 may comprise dimension criteria for selectively assigning access within a role. These dimensions enable fine-grained, contextual entitlement assignment such that access may be selectively granted to different subsets of DAR members based on the assignment context attribute values applicable to each member. In certain embodiments, each role dimension of a DAR 166 includes a dimension criteria expression and mapping to entitlements that should be granted to any members of that DAR 166 who have been assigned to the dimension.

According to one embodiment, identity management system 150 implements an object model in which RBAC roles 164, DARs 166, and dimensions 160 are objects. Table 1 below illustrates a non-limiting example of the properties of a DAR object according to one embodiment.

TABLE 1

| General Properties | Description |
|---|---|
| Role ID | The unique identifier for the Role. |
| Role Name | The unique name for the Role. |
| Role Description | A description of the Role. |
| Role Owner | A user who is designated owner of the Role. |
| Role Membership | Description |
| Role Membership Criteria | An attribute expression that evaluates user |
| | identity profile to determine which users |
| | should be assigned as members of the role. |
| Membership List | A list of users that are assigned as members of |
| | the role (current membership). |
| Assignments | History role assignment, (e.g., users that have |
| | been assigned as members of the role). |
| Access Request Configuration | Description |
| Access Request Enabled | Flag to indicate if the role can be requested. |
| Approval Required | Flag to indicate if approval is required to be a |
| | member of the role. |
| Approvers | List of Identities who must approve role |
| | membership requests. |
| Role Access Items | Description |
| Entitlements (Role) | List of entitlements to assign to all role |
| | members. |
| Access Profiles (Role) | List of access profiles (entitlement groups) to |
| | assign to all role members. |
| Dimensions | Description |
| Dimensional | Flag to indicate if a role supports dimensional |
| | access assignments. |
| Context Attributes | List of the attributes that comprise the |
| | assignment context for the role. These |
| | attributes are used to determine dimensional |
| | assignments. |
| Dimension References | List of the dimensions that the role contains. |

An RBAC role object may similarly include the General Properties, the Role Membership Properties, the Access Request Configuration properties, and the Role Access Items properties, but does not include the Dimensions properties.

Table 2 below illustrates a non-limiting example of properties of a dimension object according to one embodiment.

TABLE 2

| General Properties | Description |
|---|---|
| ID | The unique identifier for the dimension. |
| Name | The name for the dimension (unique within |
| | the Role). |
| Description | A description of the dimension. |
| Dimension Membership | Description |
| Dimension Criteria | An attribute-based expression that evaluates a |
| | role member's context (dimensional) attribute |
| | values to determine if the role member should |
| | be assigned to the Dimension and be |
| | provisioned with the Dimension's access |
| | items. |
| Dimension Access Items | Description |
| Entitlements | List of entitlements to assign role members |
| (Dimension) | who meet the criteria for the dimension. |
| Access Profiles | List of access profiles (entitlement groups) to |
| (Dimension) | assign to all role members who meet the |
| | criteria for the dimension. |

A DAR 166 according to Table 1 may include one or more dimensions 160 according to Table 2 (as role dimensions) through references to the dimensions (e.g., the Dimension References property). In some embodiments, a given dimension 160 may be assigned through multiple DARs. In other embodiments, each dimension 160 is exclusive to a DAR. 166, though the DAR 166 may have multiple dimensions. In the embodiment of Table 2, entitlements may be assigned to a dimension individually or as a member of an entitlement group. In certain embodiments, the assignment of a dimension to an identity is dependent on assigning a DAR including the dimension to the identity.

The dimension criteria of a dimension may evaluate the values of once or more context variables. A DAR may thus encode single-attribute and multi-attribute, context-sensitive access conditions. In certain embodiments, each dimension of a DAR corresponds to a unique combination of attribute-value conditions, where a combination of attribute-value conditions may include a single attribute-value condition or multiple attribute value conditions.

Identity management system 150 may automatically assign RBAC roles 164 and DARs 166 to users or may assign them in response to ad-hoc access requests or according to other assignment processes. The identity management system 150 may include an access request interface 170 through which users may request role assignments and approve role assignments. The access request (e.g., a role assignment request) includes assignment context information that is used to calculate and assign role dimensions to a user. The context information can be sourced from the assigned user's identity profile or it may be provided by the person who is manually requesting the role assignment or may be obtained from another source. In some embodiments, a portion of the assignment context information is obtained for the user's identity profile and a portion is provided by a person requesting the role assignment.

When a user is assigned as a member of an RBAC or DAR, the user is granted the entitlements 162 assigned to the RBAC role 164 or the DAR 166 (at the role level). For a user assigned as a member of a DAR 166, identity management system 150 further determines which role dimensions of the DAR the user should be granted by evaluating each dimension's criteria expressions using the user's assignment context attribute values. The user is then granted the entitlements 162 that are mapped to any dimensions 160 that they have been assigned, in addition to any entitlements 162 assigned to the DAR 166 at the role level.

Accordingly, the identity management system 150 evaluates an access request to determine if the user qualifies for a role and any corresponding role dimensions to which the user is to be assigned, as well as the entitlements that result from those assignments. Based on the applicable role-level and dimension-level entitlements granted to the user, the identity management system 150 provisions the entitlements—that is, provisions the associated access rights to the user. To that end, identity management system 150 includes a provisioning service 172 for interacting with the applications and systems of enterprise computing environment 100 to provision and deprovision access rights. Provisioning includes modifying a user's access within enterprise computing environment 100, such as creating accounts, updating account attributes, adding the user to groups, assigning the user to application-specific roles, establishing permissions, updating access control lists, or modifying other authorization data or taking other actions to implement the granted entitlements. Conversely, when an entitlement is revoked, provisioning service 172 performs deprovisioning operations to deprovision the entitlement, removing or disabling the access rights within enterprise computing environment 100 previously granted through that entitlement.

In certain embodiments, when a dimension modification to a DAR 166 having current members is detected (e.g., a dimension is removed from the DAR, a dimension is added to the DAR, the dimension criteria of a dimension is modified), identity management system 150 may automatically propagate the change to members of the DAR. Accordingly, dimensional updates to a DAR may be applied retroactively and consistently across all existing role members without requiring manual reassignment or administrative intervention. In some embodiments, automatically propagating a dimension modification comprises one or more of: i) when a dimension is added to a DAR as a new role dimension, automatically evaluating the set of context attributes associated with the members of the DAR to assign the role dimension to qualifying members and granting the corresponding dimension-level entitlements to the qualifying members; ii) when a role dimension is removed from a DAR, automatically unassigning the dimension from the members of the DAR to which the dimension was assigned and revoking the entitlement granted through that role dimension from those members; iii) when the dimension criteria for a role dimension of a DAR is changed, automatically evaluating the set of context attributes associated with the members of the DAR to assign the role dimension to qualifying members and unassign the role dimension from members who no longer qualify, granting or revoking the dimension-level entitlements accordingly; iii) when a new entitlement is added to a role dimension, automatically granting the entitlement to members assigned the role dimension; iv) when an entitlement is removed from a role dimension, automatically revoking the entitlement from members assigned the role dimension. Automatically propagating a dimension modification can include provisioning or deprovisioning access rights based on the entitlements that are assigned or unassigned due to the modification.

In further embodiments, dimension modifications to a DAR may result in the generation of access requests that require approval by an authorized user. For example, when a new role dimension is added to a DAR that requires role assignment approval, identity management system 150 may automatically generate access requests to add one or more role members to the new dimension, where such access requests require approval by an authorized user.

In some embodiments, when a user's membership in a DAR 166 is revoked, whether due to explicit removal of the user as member, expiration of a role assignment, or deletion of the DAR itself, the identity management system 150 automatically unassigns all role dimensions previously assigned to the user through the DAR and revokes the entitlements granted through the DAR, including both role-level entitlements and any dimension-level entitlements and deprovisions the entitlements.

In some embodiments, dimension assignments associated with a DAR 166 may include an explicitly defined expiration parameter. Upon reaching the specified expiration time, the identity management system 150 automatically terminates the user's assignment to the corresponding dimension and revokes all dimension-level entitlements granted through that dimension and deprovisions the entitlements. Thus, time-bounded or temporary access conditions can be enforced, reducing or eliminating manual cleanup and increasing the efficiency of periodic administrative review.

It should be noted, however, that in the foregoing revocation scenarios, removal of a dimension 160 or entitlement 162 associated with a particular DAR does not preclude the user from retaining equivalent or overlapping access rights if such rights are also assigned through another path such as another role (RBAC role or DAR) or role dimension or a direct entitlement grant. The identity management system 150 therefore can ensure that entitlements are revoked only to the extent they are uniquely attributable to the DAR or dimension being modified or removed while preserving entitlements that remain valid under alternative access pathways.

Identity management system 150 may maintain an audit record of which users were assigned to a DAR and when (e.g., membership start and end). Such audit information may further include the role dimensions, if any, assigned to each user, when the role dimensions were assigned and revoked from each user and other information for tracking which entitlements were assigned to which users and when.

As an illustrative use case of DARs, an enterprise may configure a Sales_Clerk DAR comprising multiple role dimensions corresponding to different store locations (e.g., a dimension having an associated store_location attribute-value condition. When a first authorized user (e.g., a manager) initiates a role assignment for an employee through an interface of the identity management system 150, the system may present a role-assignment form including a selectable field, such as a drop-down menu, enumerating available store-location context attribute values. The authorized user may select none, one, or multiple locations. In one example, the authorized user selects two store locations, location_1 and location_2. The system generates an access request for assigning the employee to the Sales_Clerk DAR, the access request including the selected location values as assignment context attribute values for the store_location attribute (e.g., store_location: location_1, location_2).

A second authorized user (e.g., the designated owner or approver of the Sales_Clerk role) may be responsible for reviewing and approving the role assignment. When the approver accesses the approval interface, the interface presents the access request along with an indication that the employee is to be assigned to the Sales_Clerk DAR with two specified store-location context values. The approver may approve the role assignment and selectively approve or reject each location or deny the role assignment in its entirety. Upon approval, the store_location attribute associated with the user (e.g., as part of the user's identity profile) may be updated to include the approved location(s), if any. Further, the identity management system 150 proceeds with role- and dimension-level evaluation of the access request using the approved locations(s) as the assignment context attribute values for dimension assignment, to thereby provision the role-level entitlements and applicable dimension-level entitlements.

If operational conditions change (for example, the employee ceases work at one location and begins work at a newly added location) an authorized user may access the employee's current profile through the identity management system 150 and see that the employee is assigned the Sales_Clerk role. By selecting the Sales_Clerk role through this view, the authorized user may see that the employee has location_1 and location_2 assigned. The authorized user may deselect location_2 and select location_3, prompting the system to generate a new access request reflecting the updated assignment context. Assuming both locations are approved, the store_location attribute may be updated for the user to remove location_2 and add location_3. The identity management system 150 proceeds with role- and dimension-level evaluation of the access request using location_1 and location_3 s as the assignment context attribute values for dimension assignment. In this case, the identity management system 150 will i) retain the assignment of the dimension associated with location_1 and the associated dimensional entitlements for the employee; ii) unassign the dimension associated with location_2 from employee and deprovision the entitlements granted to the employee through that dimension; and iii) assign the dimension associated with location_3 to the employee and provision the employee with the entitlements granted through that dimension.

If the second store location is decommissioned or otherwise removed from enterprise operations, an authorized administrator may update the Sales_Clerk DAR configuration to remove the role dimension corresponding to that location. In some embodiments, removal of a role dimension from a DAR causes the identity management system 150 to automatically unassign the removed dimension from all role members previously mapped to that dimension and deprovision any entitlements granted through it, unless those entitlements are independently granted through another DAR, another dimension, another role, or via direct entitlement assignment.

An authorized administrator may further augment the Sales_Clerk DAR by introducing additional dimensions. For example, the administrator may define a new set of dimensions based on store-specific groups, where each such dimension corresponds to a different store location and grants access to a location-specific store calendar. In certain embodiments, the identity management system 150 automatically re-evaluates the assignment context attributes of all current role members (e.g., the store_location attribute for current role members) to determine whether they satisfy the criteria for the newly added dimensions and, if so, provisions the corresponding entitlements.

In the preceding example, the Sales_Clerk DAR dimensions were derived from a single context attribute, namely store_location. However, DAR dimensions may be defined using multiple context attributes, such as location and shift, location and job classification, or other enterprise-specific identity attributes. Using the example of location and shift, when assigning the Sales_Clerk role, the authorized user may be presented with drop down menus or other controls from which the authorized user may select from available values for the store location and shift attributes. Thus, for example, the authorized user may request to assign the employee the Sales_Clerk role, location_1, location_2, the day shift at location_1 (e.g., location_1_day) and the night shift at location_2 (e.g., location_2_night). The values of the location and shift attributes can be included as assignment context values for the request, approved, persisted for the employee and used for contextual dimensional assignment and entitlement provisioning.

As another illustrative use case for dynamic access roles (DARs), an enterprise may define a Consultant_Project_Teams DAR for controlling consultant access to a time-tracking and project-reporting system. In this example, consultants may require access privileges that vary by project assignment, and project assignments may change frequently based on staffing needs. The enterprise typically maintains more than one hundred active projects at any given time, with new projects being initiated and existing projects being completed or retired on a weekly basis. Each DAR dimension corresponds to a respective project, and each project assignment requires specification of both the project identifier and an expiration date governing the duration of the consultant's access.

When a manager seeks to assign a consultant to one or more projects, the manager interacts with an access-request interface of the identity management system 150 and initiates a request for the Consultant_Project_Teams DAR. Upon selecting the DAR, the system presents a role-assignment form including a selectable list of active project identifiers. The manager may select one or more projects and specify an expiration date for each selected project. For example, the manager selects Project Sparrow as the project assignment for the consultant, designates an expiration period of 90 days, and submits the access request. The access request includes the selected project context and the expiration value.

A second authorized user (for example, a member of a designated project-approval team) may be responsible for approving access to project-specific resources. When the approver receives an approval task corresponding to the access request, the approval interface displays the requested assignment to the Consultant_Project_Teams DAR including the specific project (Project Sparrow) and the requested expiration period. The approver may approve or deny the request in whole, or, in embodiments where multiple projects are requested simultaneously, may approve or deny individual project assignments independently. Upon approval, the identity management system 150 evaluates the request, assigns the consultant to the DAR, evaluates the dimension criteria for Project Sparrow, and based on satisfaction of the criteria, assigns the corresponding project dimension and provisions the dimension-level entitlements.

If the consultant's project assignment changes (e.g., the consultant is no longer participating in Project Sparrow but is newly assigned to Project Blue Jay) an authorized user may retrieve the consultant's current role-assignment data via the identity management system 150 to change the project assignment. The system displays the consultant's existing assignment to the Consultant_Project_Teams DAR and the assignment to Project Sparrow. The authorized user may deselect Project Sparrow, add Project Blue Jay, specify a new expiration period (e.g., 90 days), and submit a modified access request. Upon approval of the modification, identity management system 150 evaluates the request, unassigns the Project Sparrow dimension, automatically deprovisions any entitlements granted to the consultant solely through the Project Sparrow dimension, assigns the Project Blue Jay dimension and provisions the entitlements associated with the Project Blue Jay dimension. If the expiration period for the consultant for Project Blue Jay expires before the consultant is otherwise unassigned from Project Blue Jay, identity management system 150 automatically unassigns the consultant from Project Blue Jay and deprovisions any entitlements granted to the consultant solely through the Project Sparrow.

As projects are completed, a role administrator may update the Consultant_Project_Teams DAR to remove dimensions corresponding to completed or inactive projects. For example, when Project Sparrow is completed, the administrator removes the Project Sparrow dimension from the DAR. In some embodiments, removal of the dimension causes the identity management system 150 to automatically unassign that dimension from all members currently associated with it and deprovision any entitlements granted exclusively through that role dimension, while preserving entitlements granted through alternative paths.

Because the enterprise frequently adds new projects and retires existing ones, the administrator may also update the list of permissible project values and create or delete associated DAR dimensions accordingly. For example, in a given week, the enterprise may add ten new projects and retire five existing projects. The administrator updates the project context attribute value list and creates new dimensions for the ten new projects. In some embodiments, the identity management system 150 automatically re-evaluates all existing members of the Consultant_Project_Teams DAR against the updated dimensions, assigning new dimensions where appropriate, revoking dimensions associated with retired projects, and provisioning and deprovisioning entitlements accordingly.

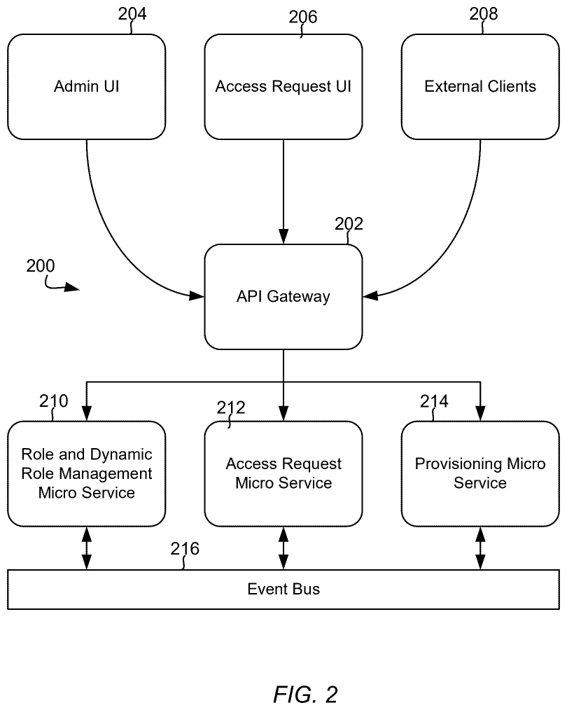

Turning now to FIG. 2, DARs may be implemented in a cloud-based microservice architecture, one embodiment of which is illustrated in FIG. 2. In the embodiment of FIG. 2, a DAR system 200 includes an application programming interface (API) gateway 202 or other interface that can be accessed and used by remote computers to provide an admin user interface (UI) 204 and an access request UI 206. External clients 208 may also use API gateway 202. The microservices include role and dynamic management microservice 210, access request microservice 212, and provisioning microservice 214. The microservices communicate with other software components of the cloud-based architecture via an event bus 216. Through admin UI 204, a user with sufficient privileges (e.g., a role administrator) can interact with role and dynamic management microservice 210 to define roles, entitlements, and dimensions and take other management actions.

Through access request UI 206, authorized users can interact with access request microservice 212 to request role assignments and approve access requests. Similarly, access requests may be received from external clients 208 for role assignments. An access request may include an identity profile or otherwise include identity attributes of the user or other attributes that are used to determine membership in roles and the assignment of role dimensions. Access request microservice 212 evaluates the access request and determines the entitlements to be assigned to the user. Provisioning microservice 214 provisions the entitlements to the user.

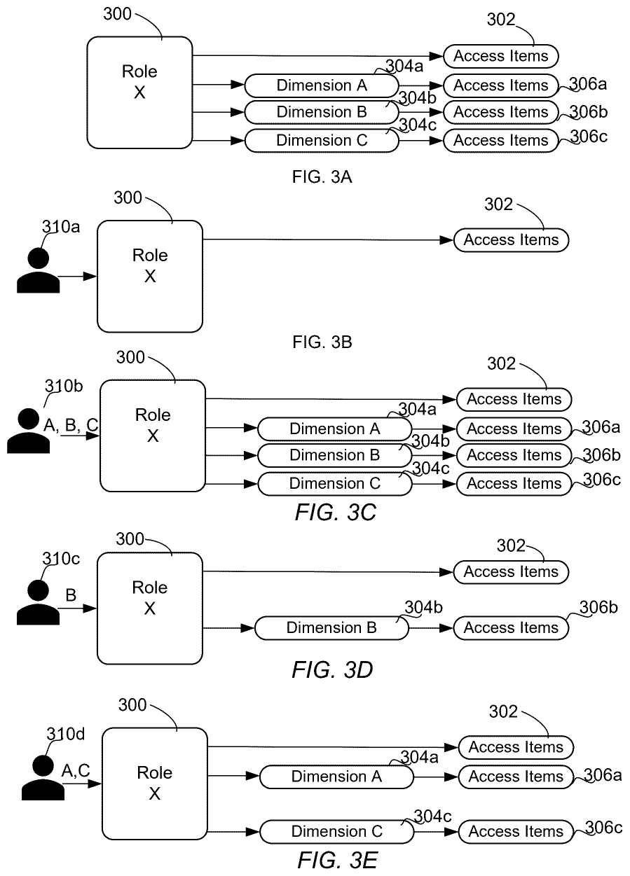

FIG. 3A illustrates an example embodiment of a DAR 300 which has associated role access items 302 (e.g., entitlements or entitlement groups) to assign to all users who are assigned as members of DAR 300. DAR 300 further includes three dimensions: dimension 304a with access items 306a to be assigned to role members who meet the criteria for dimension 304a, dimension 304b with access items 306b to be assigned to role members who meet the criteria for dimension 304b, and dimension 304c with access items 306c to be assigned to role members who meet the criteria for dimension 304c. The access items represent access rights that can be provisioned in one or more target applications or systems.

When a user is assigned as a member of the role, the system assigning roles and access determines which dimensions the user should be granted by evaluating each dimension's criteria expressions using the user's context attribute values. The user is then granted all access items that are mapped directly to the role and all access items that are mapped to any dimensions that they have been granted.

Turning to FIG. 3B, an access request is received to assign DAR 300 to user 310a. For example, the request is received based on a user with permissions to assign the role interacting with an access request user interface (UI) or client application or from a service that has determined that the role should be assigned. The user's identity attributes are evaluated to determine that the user qualifies to be a member of DAR 300 and user 310a is assigned as a member of DAR 300. However, the access request does not include context that meets the criteria for any of the dimensions of DAR 300. User 310a is thus assigned access items 302, but not access items 306a, access items 306b, or access items 306c.

In FIG. 3C, a role assignment request is received to assign DAR 300 to user 310b. The user's identity attributes are evaluated to determine that the user qualifies to be a member of DAR 300 and user 310b is assigned as a member of DAR 300. User 310b is thus assigned access items 302. In this example, the access request includes a role assignment context that meets the criteria for dimension 304a, dimension 304b, and dimension 304c. User 310b is thus also assigned access items 306a, access items 306b, and access items 306c.

In FIG. 3D, an access request is received to assign user 310c to DAR 300. The user's identity attributes are evaluated to determine that the user qualifies to be a member of DAR 300 and user 310c is assigned as a member of DAR 300. User 310c is thus assigned access items 302. The access request includes a role assignment context that meets the criteria for dimension 304b. User 310c is thus also assigned access items 306b but not access items 306a or access items 306b.

In FIG. 3E, an access request is received to assign user 310d to DAR 300. The user's identity attributes are evaluated to determine that the user qualifies to be a member of DAR 300 and user 310d is assigned as a member of DAR 300. User 310d is thus assigned access items 302. The access request includes a role assignment context that meets the criteria for dimension 304a and dimension 304c. User 310d is thus assigned access items 306a and access items 306c but not access items 306b.

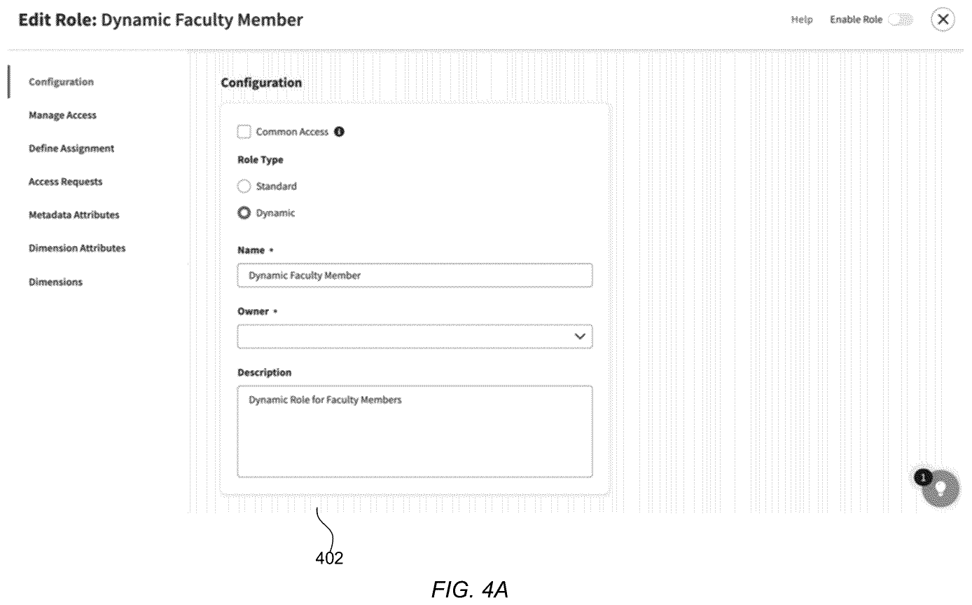

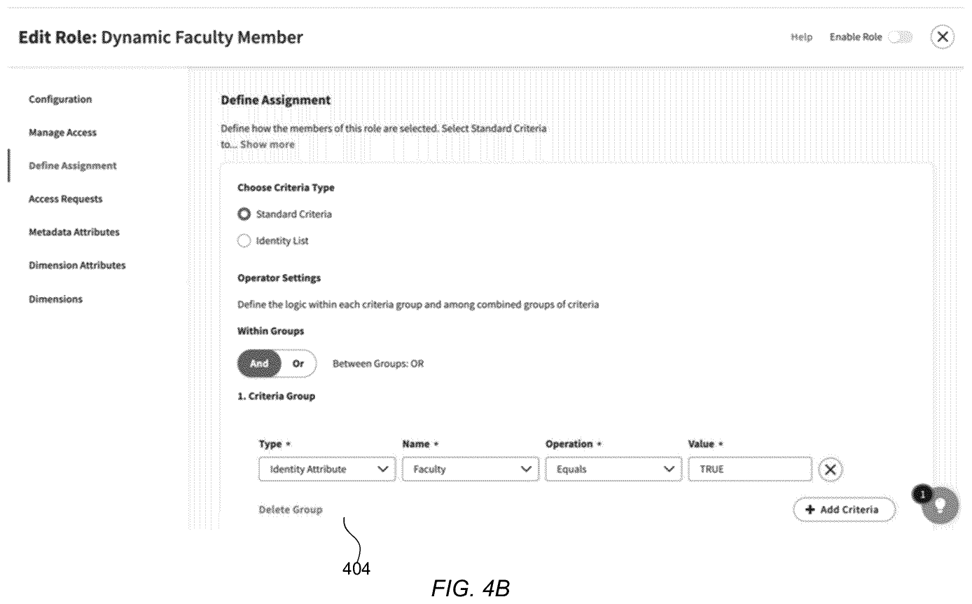

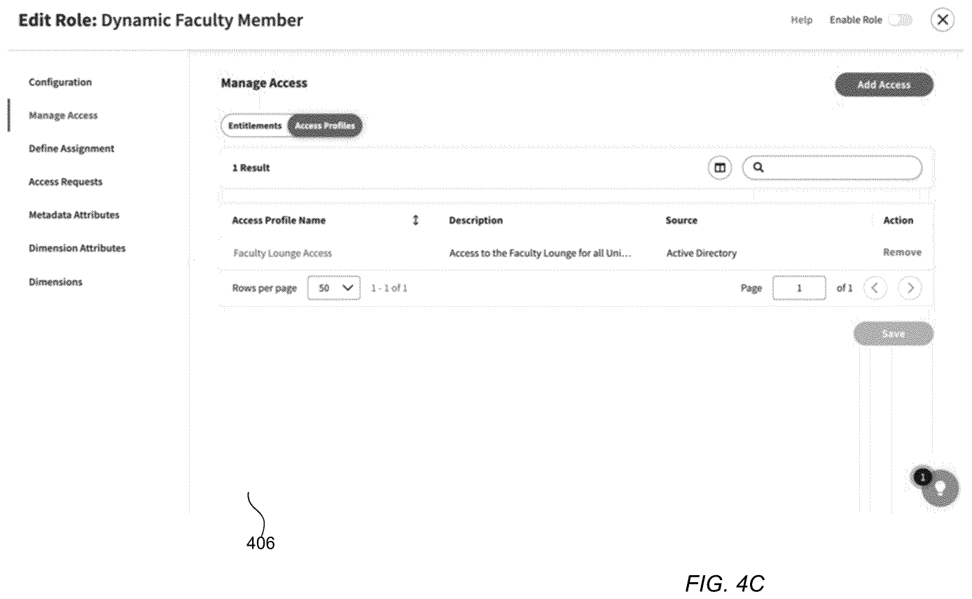

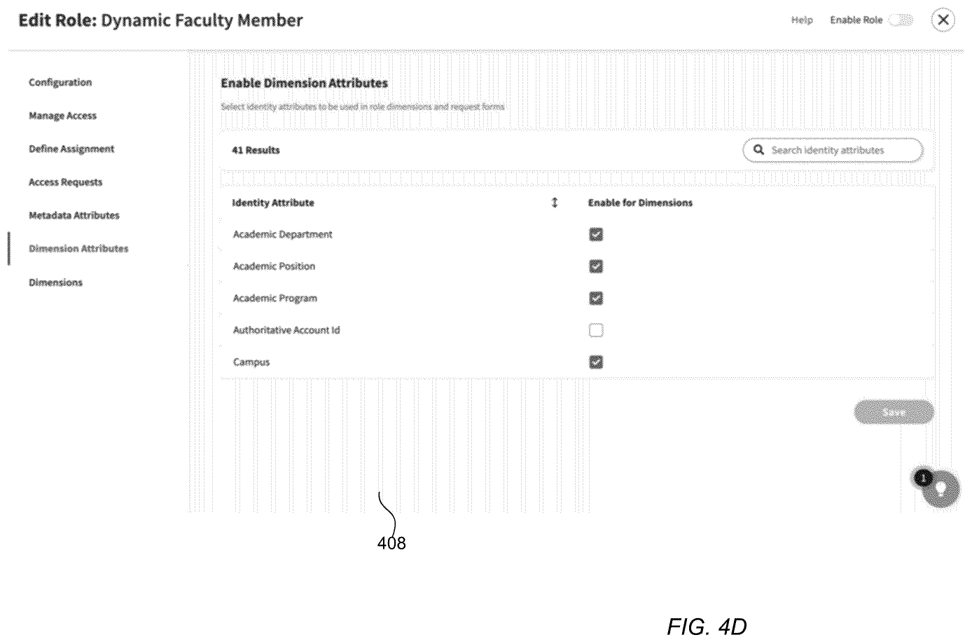

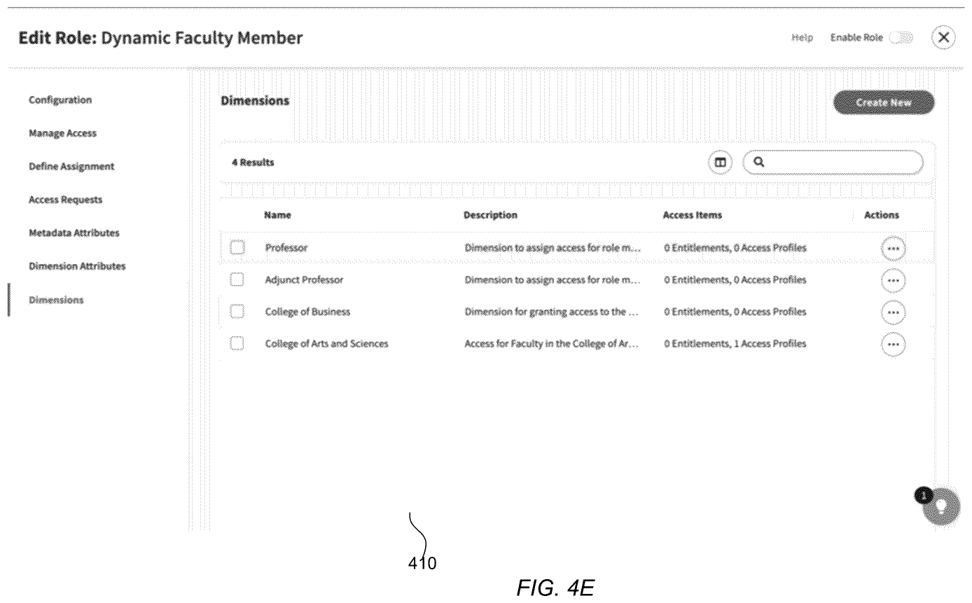

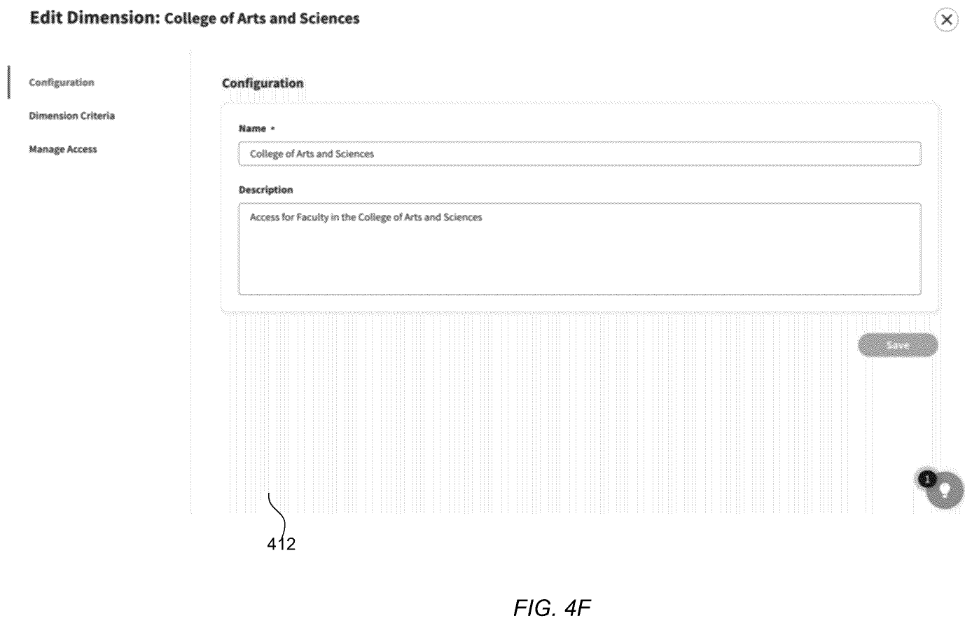

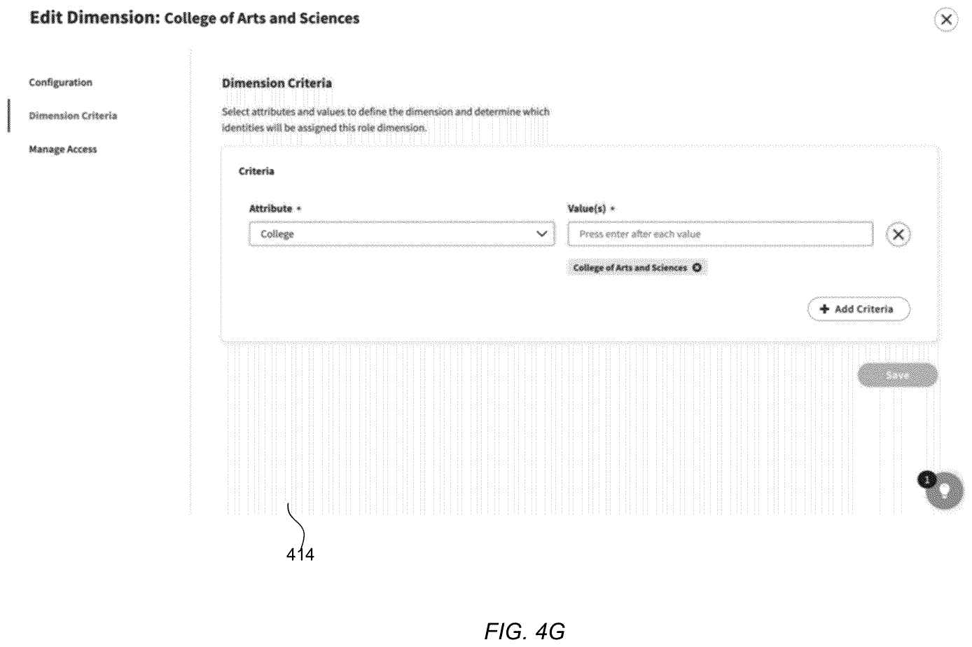

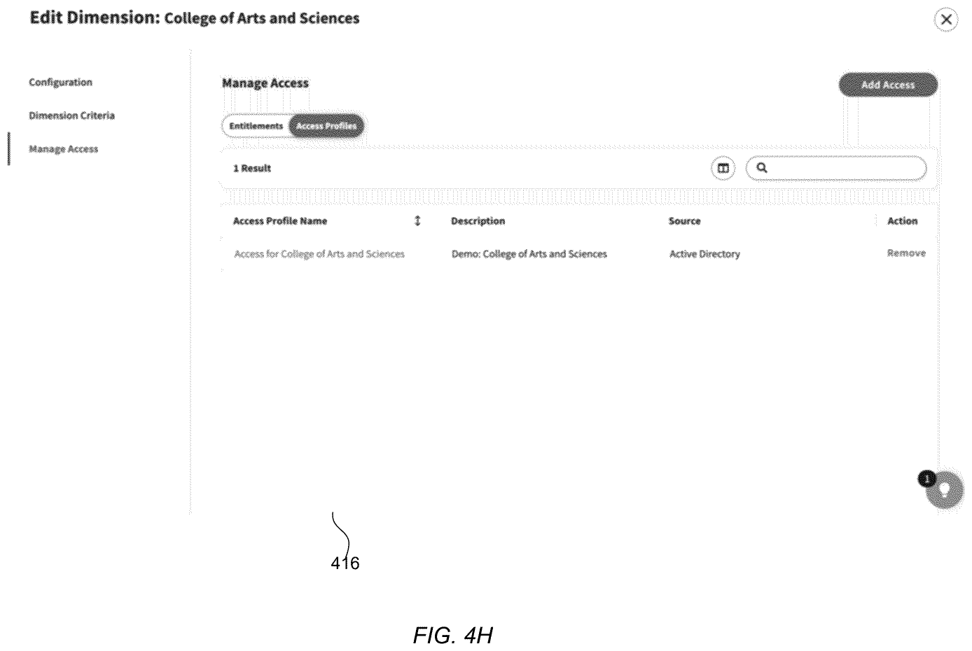

FIG. 4A illustrates one embodiment of a UI screen 402 used by a role administrator to create or edit a role. In this example, the role administrator creates a Dynamic Faculty Member role. Here, since the role is indicated as “Dynamic” the corresponding “dimensional” flag in the role will be set (see Table 1).

FIG. 4B illustrates an example UI screen 404 used by the role administrator to specify members or membership criteria for role membership. As will be appreciated, the identity profiles of users can include a number of identity attributes. The role administrator can define dimension criteria expressions on the identity attributes for assigning users to roles. In this example, when an access request for a user is received and the user's identity profile includes an identity attribute “Faculty” having the value “True,” the user will be assigned to the Dynamic Faculty Member role.

FIG. 4C illustrates an embodiment of a UI screen 406 used to assign access items to a role. In this example, the role administrator assigns the access profile “Faculty Lounge Access” to the Dynamic Faculty Member role. The access profile, in this case, is a previously defined bundle of entitlements.

FIG. 4D illustrates an embodiment of a UI screen 408 used to select which identity attributes are to be used in role dimensions. In other words, the UI screen of FIG. 3D can be used to set the context attributes for the role. In this example, the role administrator selects the identity attributes “Academic Department,” “Academic Position,” “Academic Program,” and “Campus” as the context attributes.

FIG. 4E illustrates an embodiment of a UI screen 410 used to select the dimensions that apply to the role (e.g., the Dynamic Faculty Member role). The role administrator can select from already defined dimensions for the role, edit dimension, or create new dimensions for the role.

FIG. 4F illustrates an embodiment of a UI screen 412 used to edit a dimension. In this example, the role administrator has selected to edit the “College of Arts and Sciences” dimension from FIG. 4E and can edit the dimension name and description.

FIG. 4G illustrates another embodiment of a UI screen 414 used to edit a dimension and, more particularly, to assign dimension criteria. Using the UI screen of FIG. 3G, the role administrator can define an attribute-based dimension criteria expression that evaluates a role member's context attribute values to determine if the role member should be assigned to the dimension and be provisioned with the dimension's access items. Attribute value pairs can be combined in AND statements (all criteria must be met to be assigned a dimension) OR statements (at least one criterion must be met) or other combinations. In this example, “College” has the value “College of Arts and Sciences” is defined as the dimension criterion for the College of Arts and Sciences dimension.

FIG. 4H illustrates another embodiment of a UI screen 416 used to edit a dimension and, more particularly, to assign access items to the dimension. In this example, the role administrator assigns that access profile “Access for College of Arts and Sciences” to the dimension “College of Arts and Sciences” of the Dynamic Faculty Member role.

Using the example of FIGS. 4A-4H, when an access request is received for a user and that user's identity profile has the attribute Faculty: True, the user is assigned to the Dynamic Faculty Member role and provisioned entitlements according to the Faculty Lounge Access Profile. If the user's identity profile also includes the attribute College: College of Arts and Sciences, the user will also be assigned the College of Arts and Sciences dimension and provisioned the entitlements specified by the Access for College of Arts and Sciences access profile.

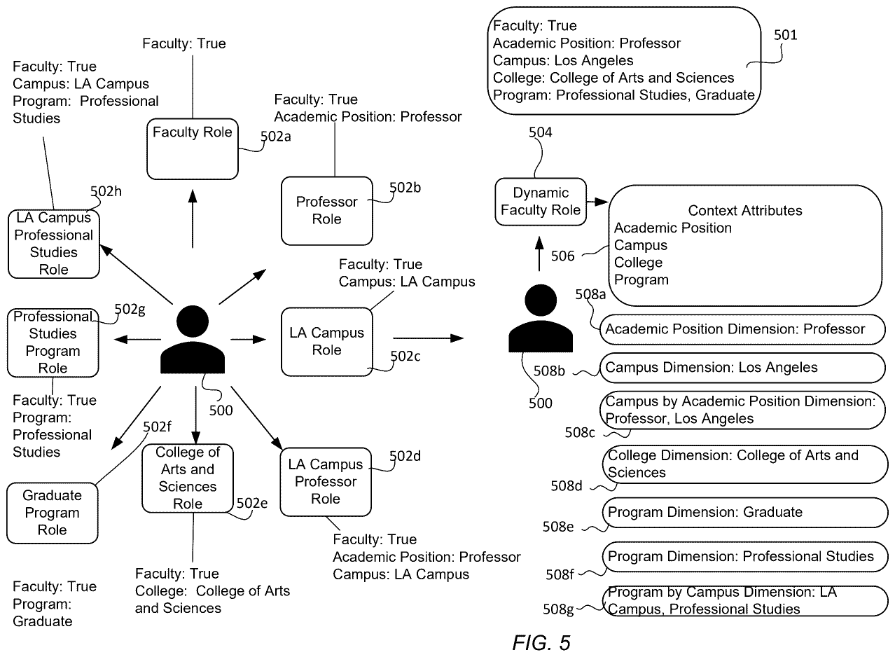

FIG. 5 illustrates an embodiment of assigning access rights using standard roles versus a DAR. In this example it is assumed that an organization assigns access to faculty members (a faculty role) and that additionally some faculty access is assigned based on academic position (six academic positions), college (ten colleges), program (five programs), campus (ten campuses), the combination of academic position and campus (60 combinations) and the combination of program and campus (50 combinations). Using RBAC roles, 142 RBAC roles would have to be defined (1 faculty role, 10 campus roles, 10 college roles, 6 academic position roles, 5 program roles, 60 academic position by campus roles, and 50 program by campus roles). Alternatively, one Faculty DAR can be defined that declares the dimension attributes Academic Position, Campus, College, Program and includes 10 campus dimensions, 10 college dimensions, 6 academic position dimensions, 5 program dimensions, 60 academic position by campus dimension, and 50 program by campus dimensions.

In the standard RBAC roles example, a user 500 with identity attributes 501 (only a portion of which are illustrated) is assigned eight distinct and separately managed roles 502a-502h to provide the user 500 with access rights needed. In the DAR example, on the other hand, the user may be assigned as a member of the DAR 504 that comprises context attributes 506 and based on the context-attribute values for the user, they may be assigned dimensions 508a-508g.

In some implementations, a single DAR 504 with 141 dimensions requires less metadata and management overhead than implementing similar access rights through 142 separately managed RBACs. Furthermore, the use of a DAR can reduce redundant evaluation of attributes.

Moreover, in RBAC systems each role typically has to have a unique name, leading to convoluted and cryptic names that make administration and assignment of roles difficult. The example role model above would require 142 unique role names. Now consider that there may also be similar student roles, etc. In a system with hundreds, thousands or more roles, maintaining role names that are understandable to business users—the users who are typically assigning roles to others—becomes untenable. However, in certain embodiments, dimension names are unique within a DAR but do not have to be unique between DARs. Thus, several DARs may each have a role dimension with the same name, but different dimension criteria or entitlements. For example, the faculty DAR may have a “Los Angeles Campus” dimension and a student DAR may have a “Los Angeles Campus” dimension where the faculty DAR Los Angeles Campus dimension and the student DAR Los Angeles Campus dimension have different entitlements. Thus, the role model using DARs can be much easier for users to manage and understand compared to using RBAC roles.

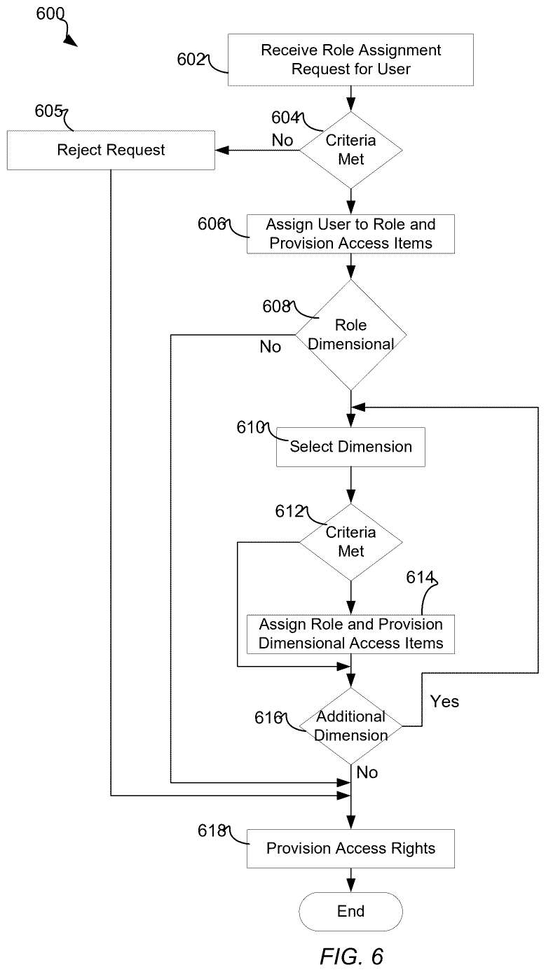

FIG. 6 is a flowchart illustrating one embodiment of a method 600 for provisioning entitlements. One or more steps of method 600 may be embodied as computer-translatable instructions stored on a non-transitory, computer-readable medium. One or more steps of method 600 may be performed by a DAR system, such as identity management system 150 of FIG. 1 or system 200 of FIG. 2.

At step 602, an access request is received. The access request may include a role assignment context with a user for which a role is requested. At step 604, a determination is made as to whether the user meets the criteria for membership of the role. According to one embodiment, an attribute expression is evaluated to determine if the user should be assigned as a member of the role. If the role membership criteria are not met, the request is rejected (step 605). If the role membership criteria are met, the user is assigned as a member of the role and provisioned with the role access items that are assigned to all role members (step 606).

If the user qualifies for a membership in the role, a determination can be made if the role is dimensional (step 608). For example, the dimensional flag for the role can be checked. If the role is not dimensional, the method can end. If the role is dimensional, a dimension from the role is selected (step 610). At step 612, a determination is made as to whether the user meets the dimension criteria for the selected dimension. For example, an attribute expression is evaluated using the role assignment context to determine if the role member should be assigned to the dimension. If the dimension criteria are met, the user is provisioned with the access items assigned to the dimension (step 614). At step 616, a determination is made as to whether the role includes additional dimensions that have not been evaluated for the user. If so, the next dimension of the role can be evaluated and so on until all of the dimensions of the role have been considered. At step 618, the access rights represented by the assigned access items are provisioned for the user.

FIG. 6 is merely an illustrative example, and the disclosed subject matter is not limited to the ordering or number of steps illustrated. Embodiments may implement additional steps or alternative steps, omit steps, or repeat steps.

In some embodiments, the process of assigning a role may go through a workflow involving several types of users. For example, a manager may submit an access request for an employee to request that the employee be assigned to a role, a role owner (or other authorized user) may be responsible for approving assignment to the role and, in some embodiments, assignment to dimensions within the role.

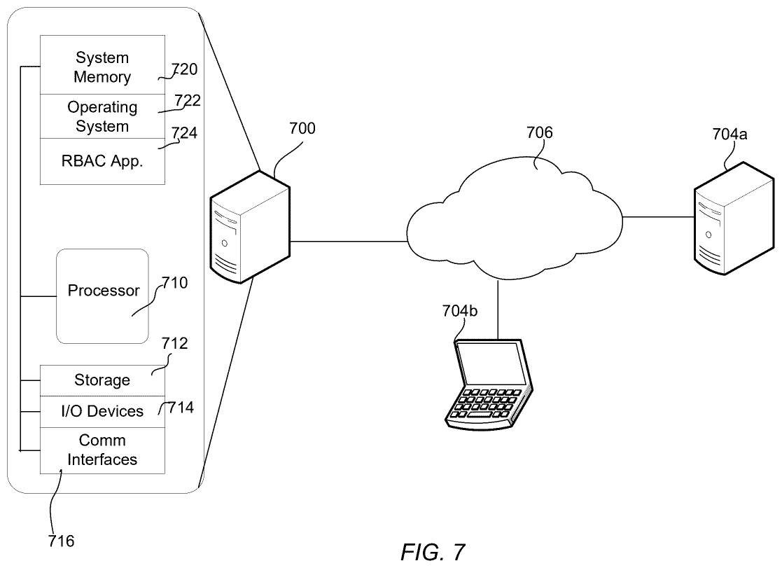

FIG. 7 illustrates one embodiment of a computer system 700. Computer system 700 includes a processor 710 and memory 720. Depending on the exact configuration and type of computing device, memory 720 (storing, among other things, executable instructions) may be volatile (such as RAM), non-volatile (such as ROM, flash memory, etc.), or some combination of the two. Further, computer system 700 may also include storage devices 712, such as, but not limited to, solid state storage. Similarly, computer system 700 may also have input device(s) and output device (I/O devices 714) such as keyboard, mouse, pen, voice input, touch screen, and speakers. Computer system 700 further includes communications interfaces 716, such as a cellular interface, a Wi-Fi interface, or other interfaces.

Computer system 700 includes at least some form of non-transitory computer-readable media. The non-transitory computer-readable readable media can be any available media that can be accessed by processor 710 or other devices comprising the operating environment. By way of example, non-transitory computer-readable media may comprise computer storage media such as volatile memory, nonvolatile memory, removable storage, or non-removable storage for storage of information such as computer readable-instructions, data structures, program modules or other data. Computer storage media includes RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information.

As stated above, a number of program modules and data files may be stored in system memory 720. While executing on processor 710, program modules (e.g., applications, Input/Output (I/O) management, and other utilities) may perform processes including, but not limited to, one or more of the stages of the operational methods described with respect to roles, including DARs. In one embodiment, system memory 720 stores an operating system 722 and an RBAC application 724 executable to provide roles-based access control, including through DARs. In one embodiment, RBAC application 724 is executable to provide components of an identity management system 150, a DAR system 200 or other system that implements DARs. Other computer systems (e.g., computer systems 704a, 704b) may connect to computer system 700 over a network 706 to manage roles and submit access requests. In some embodiments, computer 700 may be part of or connect to an enterprise computing environment, such as enterprise computing environment 100.

Those skilled in the relevant art will appreciate that the invention can be implemented or practiced with other computer system configurations including, without limitation, multi-processor systems, network devices, mini-computers, mainframe computers, data processors, and the like. The invention can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. At least portions of the functionalities or processes described herein can be implemented in suitable computer-executable instructions. The computer-executable instructions may reside on a computer readable medium, hardware circuitry or the like, or any combination thereof.

Any suitable programming language can be used to implement the routines, methods, or programs of embodiments of the invention described herein. Different programming techniques can be employed such as procedural or object oriented. Other software/hardware/network architectures may be used. Communications between computers implementing embodiments can be accomplished using any electronic, optical, radio frequency signals, or other suitable methods and tools of communication in compliance with known network protocols.

Particular routines can be executed on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps, and operations described herein can be performed in hardware, software, firmware, or any combination thereof.

It will also be appreciated that one or more of the elements depicted in the drawings/figures can be implemented in a more separated or integrated manner or even removed or rendered as inoperable in certain cases, as is useful in accordance with a particular application. Additionally, any signal arrows in the drawings/figures should be considered only as exemplary, and not limiting, unless otherwise specifically noted.

The different aspects described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

Portions of the methods described herein may be implemented in suitable software code that may reside within RAM, ROM, a hard drive, or other non-transitory storage medium. Alternatively, the instructions may be stored as software code elements on a data storage array, magnetic tape, floppy diskette, optical storage device, or other appropriate data processing system readable medium or storage device.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Although the invention has been described with respect to specific embodiments thereof, these embodiments are merely illustrative, and not restrictive of the invention as a whole. Rather, the description is intended to describe illustrative embodiments, features and functions in order to provide a person of ordinary skill in the art context to understand the invention without limiting the invention to any particularly described embodiment, feature or function, including any such embodiment feature or function described in the Appendices. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

What is claimed is:

1. An identity management system, comprising:
a processor;
a non-transitory, computer-readable storage medium including computer instructions executable by the processor for:
maintaining a dynamic access role, the dynamic access role comprising:
a role membership criteria;
a role dimension, the role dimension comprising:
a dimension criteria;
a dimension-level entitlement to be provisioned to members of the dynamic access role that satisfy the dimension criteria;
evaluating user assignment contexts to contextually assign the role dimension to users that satisfy the role membership criteria and the dimension criteria; and
provisioning the dimension-level entitlement to the users assigned the role dimension.

2. The identity management system of claim 1, wherein the dynamic access role comprises a role-level entitlement to be provisioned to all members of the dynamic access role.

3. The identity management system of claim 1, further comprising computer instructions executable by the processor for:
based on detecting a dimension modification to the dynamic access role, automatically propagating the dimension modification to members of the dynamic access role.

4. The identity management system of claim 1, wherein the dimension criteria comprises a dimension criteria expression for evaluating context attribute values for the users.

5. The identity management system of claim 4, further comprising computer instructions executable by the processor for maintaining identity profiles that comprise identity attributes for the users, wherein the context attribute values comprise values from the identity profiles.

6. The identity management system of claim 4, wherein the dynamic access role identifies a context attribute to be used for contextually based dimension assignment.

7. The identity management system of claim 1, wherein the dynamic access role comprises a plurality of role dimensions.

8. The identity management system of claim 7, wherein each of the plurality of role dimensions comprises a respective dimension criteria expression for evaluating context attribute values for the users and wherein each of the plurality of role dimensions is associated with a different combination of context attribute-value conditions.

9. A method for contextual access rights assignment within a role, the method comprising:
accessing a dynamic access role, the dynamic access role comprising:
a role membership criteria;
a role dimension, the role dimension comprising:
a dimension criteria;
a dimension-level entitlement to be provisioned to members of the dynamic access role that satisfy the dimension criteria;
evaluating user assignment contexts to contextually assign the role dimension to users that satisfy the role membership criteria and the dimension criteria; and
provisioning the dimension-level entitlement to the users assigned the role dimension.

10. The method of claim 9, wherein the dynamic access role comprises a role-level entitlement and wherein the method further comprises provisioning the role-level entitlement to all members of the role.

11. The method of claim 9, further comprising automatically propagating a dimension modification to the dynamic access role to members of the dynamic access role.

12. The method of claim 9, wherein the dimension criteria comprises a dimension criteria expression for evaluating context attribute values for the users.

13. The method of claim 12, further comprising maintaining identity profiles that comprise identity attributes for the users, wherein the context attribute values comprise values from the identity profiles.

14. The method of claim 12, wherein the dynamic access role identifies a context attribute to be used for contextually based dimension assignment.

15. The method of claim 9, wherein the dynamic access role comprises a plurality of role dimensions.

16. The method of claim 15, wherein each of the plurality of role dimensions comprises a respective dimension criteria expression for evaluating context attribute values for the users and wherein each of the plurality of role dimensions is associated with a different combination of context attribute-value conditions.

17. A non-transitory computer-readable medium including computer instructions executable for:
accessing a dynamic access role, the dynamic access role comprising:
a role membership criteria;
a role dimension, the role dimension comprising:
a dimension criteria;
a dimension-level entitlement to be provisioned to members of the dynamic access role that satisfy the dimension criteria;
evaluating user assignment contexts to contextually assign the role dimension to users that satisfy the role membership criteria and the dimension criteria; and
provisioning the dimension-level entitlement to the users assigned the role dimension.

18. The non-transitory computer readable medium of claim 17, wherein the dynamic access role comprises a role-level entitlement and wherein the non-transitory computer readable medium further includes computer instructions executable for provisioning the role-level entitlement to all members of the dynamic access role.

19. The non-transitory computer readable medium of claim 17, further computer instructions executable for automatically propagating a dimension modification to the dynamic access role to members of the dynamic access role.

20. The non-transitory computer readable medium of claim 17, wherein the dimension criteria comprises a dimension criteria expression for evaluating context attribute values for the users.

21. The non-transitory computer readable medium of claim 17, wherein the dynamic access role identifies a context attribute to be used for contextually based dimension assignment.

22. The non-transitory computer readable medium of claim 17, wherein the dynamic access role comprises a plurality of role dimensions.
